(19) United States
(12) Patent Application Publication
(10) Pub. No.: US 2013/0038784 A1
(43) Pub. Date: Feb. 14, 2013

(54) LENS APPARATUS AND IMAGING SYSTEM USING THE SAME

(71) Applicant: Masayuki Sakamoto, Tokyo (JP)

(72) Inventor: Masayuki Sakamoto, Tokyo (JP)

(73) Assignee: CANON KABUSHIKI KAISHA, Tokyo (JP)

(21) Appl. No.: 13/567,406

(22) Filed: Aug. 6, 2012

(30) Foreign Application Priority Data
Aug. 8, 2011 (JP) 2011-172969

(51) Int. Cl. H04N 5/225

(52) U.S. Cl. 348/360; 348/E05.024

(57) ABSTRACT

An imaging system includes at least a first imaging apparatus and at least a second imaging apparatus where each apparatus includes a camera apparatus including an image sensor and a lens apparatus configured to guide an object image to the image sensor, where the lens apparatus is attached to the camera apparatus.

### BACKGROUND OF THE INVENTION

1. Field of the Invention

The present invention relates to a lens apparatus, an imaging system, and a computation device for performing stereoscopic photography by using a plurality of photographing apparatuses.

2. Description of the Related Art

Conventionally, stereoscopic photography has sometimes been performed by using two imaging apparatuses each including an interchangeable lens and a camera body. To obtain a stereoscopic video image by using such two imaging apparatuses, i.e., two interchangeable lenses, it has been needed to operate the two imaging apparatuses in synchronization with each other.

For example, Japanese Patent Application Laid-Open No. 2001-148865 discusses technology for performing the same exposure control on two camera bodies.

Japanese Patent No. 3278667 discusses technology of setting either one of two zoom lenses as a master and the other as a slave, and causing the slave zoom lens to move following the motion of the master zoom lens.

According to the conventional technology discussed in Japanese Patent Application Laid-Open No. 2001-148865, there maybe a plurality of computation units that control the camera bodies and the camera bodies may individually control the respective interchangeable lenses to be paired with. In such a case, lens groups in the plurality of interchangeable lenses are difficult to operate synchronously by an identical control command.

According to the conventional technology discussed in Japanese Patent No. 3278667, a master and a salve need to be set by some method in advance, which complicates procedures.

### SUMMARY OF THE INVENTION

An aspect of the present invention is directed to an optical apparatus that performs stereoscopic photography with two or more combinations of an optical unit and an imaging unit, where all the optical units operate in synchronization with a command from an imaging unit.

According to an aspect of the present invention, an imaging system includes at least a first imaging apparatus and at least a second imaging apparatus that each include a camera apparatus including an image sensor and a lens apparatus configured to guide an object image to the image sensor, where the lens apparatus is attached to the camera apparatus. The lens apparatus from either the at least first or at least second imaging apparatuses is set as a master side lens apparatus by receiving a control command including one of a non-combined control command from the camera apparatus of either the at least first or the at least second imaging apparatuses and a combined control command generated by combining control commands from the camera apparatus of each of the at least first and the at least second imaging apparatuses, and where the control command is transmitted to a slave side lens apparatus via the master side lens apparatus to control the slave side lens apparatus, where the slave side lens apparatus is the lens apparatus other than the master side lens apparatus.

According to an exemplary embodiment of the present invention, a lens apparatus, an imaging system, and a computation apparatus for performing stereoscopic photography with two or more combinations of an optical unit and an imaging unit, wherein all the optical units can operate in synchronization with a command from an imaging unit and a master and a slave can be easily set, can be provided.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating the configuration of an imaging system according to a first exemplary embodiment of the present invention.

FIG. 2 is a state transition diagram of an optical computation unit included in an optical unit according to the first exemplary embodiment.

FIG. 3 is a block diagram illustrating an example of the configuration of an optical α computation unit and an optical β computation unit included in the imaging system according to the first exemplary embodiment.

FIG. 4 is a block diagram illustrating the configuration of an optical apparatus according to a second exemplary embodiment of the present invention.

### DESCRIPTION OF THE EMBODIMENTS

Various exemplary embodiments, features, and aspects of the invention will be described in detail below with reference to the drawings.

An imaging system according to an exemplary embodiment of the present invention is an imaging system for performing stereoscopic photography by using two partial imaging systems. A first partial imaging system (first imaging apparatus) is a system in which an optical unit (first lens apparatus) α100 and an imaging unit (first camera apparatus) α110 are combined. The optical unit α100 forms an object image. The imaging unit α110 includes a first image sensor that receives light of the object image. The first partial imaging system is a system for capturing an image to be observed with either one of the right and left eyes. A second partial imaging system (second imaging apparatus) is a system in which an optical unit (second lens apparatus, another lens apparatus) β200 and an imaging unit (second camera apparatus) β210 are combined. The optical unit β200 forms an object image. The imaging unit β210 includes a second image sensor that receives light of the object image. The second partial imaging system is a system for capturing an image to be observed with the eye different from that in the foregoing first partial imaging system. The foregoing two imaging units (camera apparatuses) α110 and β210 include the respective image sensors. The two optical units α100 and β200 each include a variator lens group that moves during zooming and a focusing group that moves during focusing. Video images captured by using the two partial imaging systems can be provided to an observer in various modes so that the observer can observe a stereoscopic image. An exemplary embodiment of the present invention is directed to an imaging system (lens apparatuses and a computation device) that can capture an image that allows the observer to observe a stereoscopic image without unconformable feeling (with less uncomfortable feeling).

The imaging system according to the exemplary embodiment of the present invention includes two imaging apparatuses, namely, the imaging apparatus including the foregoing optical unit α100 and imaging unit α110 and the imaging apparatus including the optical unit β200 and imaging unit β210. With such a configuration, the optical units (lens apparatuses) α100 and β from the imaging unit α110 or a combined control command generated by combining control commands (second control commands) from the imaging unit α110 and the imaging unit β210. An imaging system capable of stereoscopic photography is constructed with such a simple configuration.

The imaging system can be configured so that the control commands are transmitted to the optical unit α100 and then transmitted to the optical unit β200 through (via) the optical unit α100. The imaging system can be further configured so that a feedback signal (information on the position and speed of a member to be controlled) from the optical unit β200 is similarly returned to the imaging units α100 and β210 through (via) the optical unit α100. The feedback signal may be received by the imaging unit α110, the imaging unit β210, or a circuit that is in charge of combining control signals from the imaging units α110 and β210. With such a configuration, a feedback signal (position information and speed information on a member to be controlled) from the optical unit β200, concerning a member to be controlled, can be transmitted to the imaging unit α110 and the imaging unit β210 along with a feedback signal concerning a member to be controlled of the optical unit α100. As employed herein, the members to be controlled (first movable optical member and second movable optical member) in the optical units α100 and β200 may be movable optical members that move or operate. Examples include a movable lens unit that moves during zooming and/or in a focusing operation, and a variable diaphragm.

In the foregoing configuration, the optical unit α100 and the optical unit β200 can have the same optical performance. A difference between the position of the member to be controlled (first member to be controlled) in the optical unit α100 and that of the member to be controlled (second member to be controlled) in the optical unit β200 can thus be reduced. For that purpose, an ordinary control command can be rewritten into such a control command as to reduce a difference (to decrease a difference, or eliminate a difference) between the positions (or speeds or accelerations) of the two members to be controlled. In other words, based on position information on the member to be controlled in the optical unit α100 and position information on the member to be controlled in the optical unit β200 (or a difference therebetween), a correction command may be transmitted to the optical units α100 and β200 in addition to ordinary control commands (or ordinary control commands may be modified) so as to reduce a difference between the two members to be controlled. Here, a control command to the optical unit β200 can be modified to adjust the position of the member to be controlled in the optical unit β200 to the position of the member to be controlled in the optical unit α100 (optical unit or apparatus lying on the upstream side in terms of a transmission route of control commands or position commands) which relays the control signal to be transmitted to the optical unit β200. For that purpose, the optical units α100 and β200 may include detection units (first position detection unit and second position detection unit) that detect the positions (positions in translational directions and/or positions in rotational directions) of the members to be controlled, respectively. Detection results of the detection units may be used to perform the foregoing control.

When the imaging system according to the present exemplary embodiment controls the optical units α100 and β200 by using a first control command from the imaging unit α110, a control command for the optical unit β200 to receive is transmitted from the imaging unit α110 to the optical unit β200 via the optical unit α100. A feedback signal from the optical unit β200 (a detection result of the position of the member to be controlled) is initially transmitted to the optical unit α100. The feedback signal is combined with a feedback signal from the optical unit α100 and then transmitted to the imaging unit α110. The feedback signal transmitted to the imaging unit α110 may be displayed on a display unit of the imaging unit α110, such as a viewfinder, if needed. The feedback signal transmitted to the imaging unit α110 may be transmitted to the imaging unit β210 and displayed on a display device of the imaging unit β210, such as a viewfinder, if needed. The imaging units α110 and β210 may include respective wireless receiver transmitters, which may be used to make a wireless connection for transmitting and receiving signals including control commands.

Next, suppose that the imaging system according to the present exemplary embodiment controls the optical units α100 and β200 by using a combined control command. The combined control command is obtained by a combining unit combining a first control command from the imaging unit α110 and a second control command from the imaging unit β210. Even in such a case, a control command for the optical unit β200 to receive is transmitted from the foregoing combining unit to the optical unit β200 via the optical unit α100. A feedback signal from the optical unit β200 is initially transmitted to the optical unit α100. The feedback signal is combined with a feedback signal from the optical unit α100 and then transmitted to the combining unit. The feedback signal transmitted to the combining unit may be transmitted to the imaging unit α110 and/or the imaging unit β210 and displayed on their display devices, such as a viewfinder, if needed.

In the present exemplary embodiment, either one of the two optical units α100 and β200 (first and second lens apparatuses) that receives a control signal from an imaging unit that serves as a master or from the combining unit that combines control commands from the two imaging units and first establishes connection with the imaging unit or combining unit will be referred to as a master (master side lens apparatus). For example, when the imaging unit α110 serves as a master, the optical unit α100 is usually the first to establish connection with the imaging unit α110. The optical unit α100 then serves as a master (master side lens apparatus) and the optical unit β200 a slave (slave side lens apparatus).

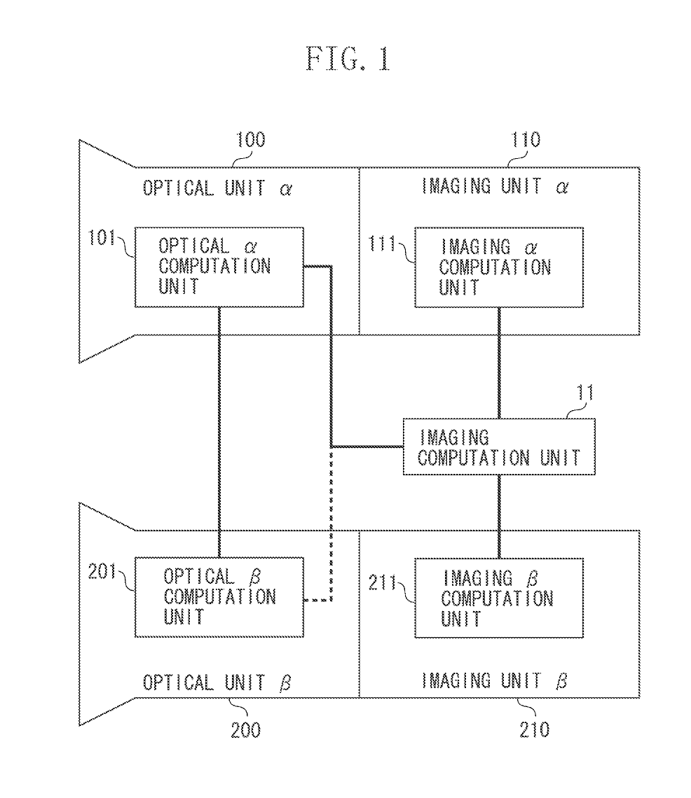

FIG. 1 is a block diagram illustrating the configuration of the imaging system (or lens apparatuses) according to the first exemplary embodiment of the present invention.

The imaging system includes an optical unit (first lens apparatus) α100 and an imaging unit (first imaging apparatus) α110. The imaging unit α110 includes a first image sensor. The imaging unit α110 and the optical unit α100 can be connected to capture a video image (record a captured video image).

The optical unit α (first optical unit) 100 includes an optical α computation unit (first control unit) 101. The optical α computation unit 101 is a computation unit for controlling the driving of a movable optical member (first movable optical member) in the optical unit α100. The optical α computation unit 101 controls a drive unit that drives the optical member based on a control command received from the imaging unit α110. Examples of the movable optical member (first movable optical member) include a not-illustrated diaphragm of the optical unit α100 and lenses (lens groups) such as a variator lens (group) and a focusing lens (group). A variator lens (group) moves during zooming. A focusing lens (group) moves in a focusing operation.

The imaging unit α (first imaging unit) 110 includes an imaging α computation unit 111. When the imaging α computation unit 111 is electrically connected to the optical α computation unit 101, the imaging α computation unit 111 can control (transmit a control command for controlling) optical members of the optical unit α100 through (via) the optical α computation unit 101.

The imaging system also includes an optical unit β (second lens apparatus) 200, an optical β computation unit (second control unit) 201, an imaging unit (second imaging unit) β210, and an imaging β computation unit 211. The imaging unit β210 includes a second image sensor. The optical unit β200, the optical β computation unit 201, the imaging unit β210, and the imaging β computation unit 211 are similar to the optical unit α100, the optical α computation unit 101, the imaging unit α110, and the imaging α computation unit 111, respectively. The imaging β computation unit 211 controls an operation of a movable optical member (second movable optical member) like the imaging α computation unit 111. In other words, the optical unit α100 and imaging unit α110 and the optical unit β200 and imaging unit β210 may be used in different combinations.

The imaging system also includes an imaging computation unit (combining unit) 11. The imaging computation unit 11 is connected to the imaging α computation unit 111 and the imaging β computation unit 211. The imaging computation unit 11 generates a new control command from control commands that the imaging α computation unit 111 and the imaging β computation unit 211 issue to the optical unit α100 and the optical unit β200. As employed herein, a new control command refers to a combined control command that is generated by selecting and combining control commands from the imaging α computation unit 111 and the imaging β computation unit 211 based on a set condition given in advance. For example, the imaging computation unit 11 may generate a new control command (combined control command) for zooming by using a control command from the imaging α computation unit 111. The imaging computation unit 11 may generate a new control command (combined control command) for a focusing operation (focusing) by using a control command from the imaging β computation unit 211. What control commands to receive and combine from which imaging computation unit (imaging unit) can be set as appropriate by a photographer. Control commands from either one of the imaging computation units (imaging units) may be exclusively selected as control commands to be transmitted to the optical units α100 and β200.

The imaging computation unit 11 can control a lens group of the optical unit α100 or the optical unit β200 with a new control command as long as the imaging computation unit 11 is electrically connected to either one of the optical α computation unit 101 and the optical β computation unit 201. In the present exemplary embodiment, the imaging computation unit 11 is connected only to the optical α computation unit 101 included in the optical unit (first lens apparatus) α100. In other words, the optical β computation unit 201 is not connected to the imaging computation unit 11. The broken line in FIG. 1 indicates the unconnected state.

In the present exemplary embodiment, the optical α computation unit 101 and the optical β computation unit 201 are connected to the imaging computation unit 11 that is separate from the imaging unit α110 and the imaging unit β210 (is arranged outside the housings of the imaging units α110 and β210). However, the arrangement of the imaging computation unit 11 is not limited thereto. For example, the imaging computation unit (combining unit that selects and/or combines signals) 11 may be arranged inside the imaging unit α110 or the imaging unit β210. The imaging α computation unit 111 or the imaging β computation unit 211 may function instead of the imaging computation unit 11.

The optical α computation unit 101 and the optical β computation unit 201 are electrically connected to each other. The optical α computation unit 101 and the optical β computation unit 201 each can enter a master state or a slave state. A computation unit in a master state can give a control command to a computation unit in a slave unit and control a lens group of the optical unit that includes the computation unit of the slave state.

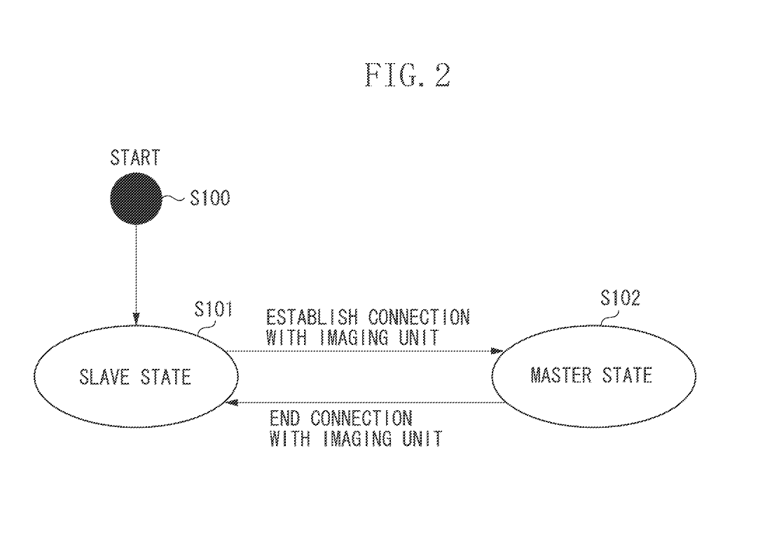

Referring to FIG. 2, state transitions of an optical computation unit included in an optical unit according to the first exemplary embodiment of the present invention will be described below. As employed herein, an optical computation unit refers to each of the optical α computation unit 101 and the optical β computation unit 201, both of which make the same operations.

This processing is performed according to a computer program stored in the optical computation unit. At power-on, the optical computation unit starts processing at state S100, and then shifts unconditionally to state S101.

State S101 is a slave state. In such a state, the optical computation unit performs operations of the slave state described above. If the optical computation unit in such a state establishes connection with the imaging computation unit 11, the optical computation unit shifts to state S102.

Suppose, for example, that the optical computation unit and the imaging computation unit 11 transmit and receive a control command by serial communication. In such a case, connection being established refers to a situation where the optical computation unit has received a control command from the imaging computation unit 11 with a successful serial communication. When connection is established, the image computation unit 11 can control the lens group of the optical unit that includes the optical computation unit through (via) the optical computation unit. Connection being ended refers to when a state where serial communication is established changes to a state where connection is not established.

State S102 is a master state. In such a state, the optical computation unit performs operations of the master state described above. If the connection with the imaging computation unit 11 ends, the optical computation unit shifts to state S101.

By performing such processing, the optical α computation unit 101 is automatically set to the master state and the optical β computation unit 201 the slave state. The setting of the master state and the slave state is uniquely determined upon electrical connection. No special setting method is thus needed.

More specifically, after power-on or after a reset operation, the imaging computation unit 11 attempts to establish connection with the optical α computation unit 111 (optical unit α100) and the optical β computation unit 201 (optical unit β200) simultaneously or in succession. In the process of the operation, either one of the optical α computation unit 101 (optical unit α100) and the optical β computation unit 201 (optical unit β200) that receives a control signal from the imaging computation unit 11 and first establishes connection with the imaging computation unit 11, which combines control commands from the imaging α computation unit 111 and the imaging β computation unit 211, automatically enters the master state. The other enters the slave state. In such a manner, an optical unit that first establishes connection with the imaging computation unit 11 that combines control commands of the imaging units α110 and β210 and outputs a control command (combined control command) automatically enters the master state. This can omit the effort of setting a master between two optical units.

The imaging computation unit (computation device) 11 transmits a combined control command to the optical α computation unit 101 of the optical unit α (first lens apparatus) 100. The imaging computation unit 11 receives position information on the movable optical member (first movable optical member) of the optical unit α (first lens apparatus) 100, and transmits the received position information to the imaging α computation unit 111 of the imaging unit α (first camera apparatus) 110. The imaging computation unit 11 also acquires positional information on the movable optical member (second movable optical member) of the optical unit β (second lens apparatus) 200 via the optical α computation unit 101 of the optical unit α (first lens apparatus) 100, and transmits the acquired position information to the imaging β computation unit 211 of the imaging unit β (second camera apparatus) 210.

The imaging computation unit (computation device) 11 may be configured so as to be attachable to the imaging unit α (first camera apparatus) 110 or the optical unit α (first lens apparatus) 100. The imaging computation unit (computation device) 11 may further include a wireless receiver transmitter for transmitting and receiving information to/from the imaging unit β (second camera apparatus) 210.

According to the configuration of the present exemplary embodiment, the optical α computation unit 101 in the master state can operate as a command distribution unit.

When the optical α computation unit 101 operates in such a state, a control command from the imaging computation unit 11 can be passed to the optical β computation unit 201 through (via) the optical α computation unit 101 included in the optical unit (first lens apparatus) α100. The optical α computation unit 101 and the optical β computation unit 201 perform control according to the control command, whereby the lens group of the optical unit α100, which includes the optical α computation unit 101, and the lens group of the optical unit β200, which includes the optical β computation unit 201, can be operated in synchronization with each other.

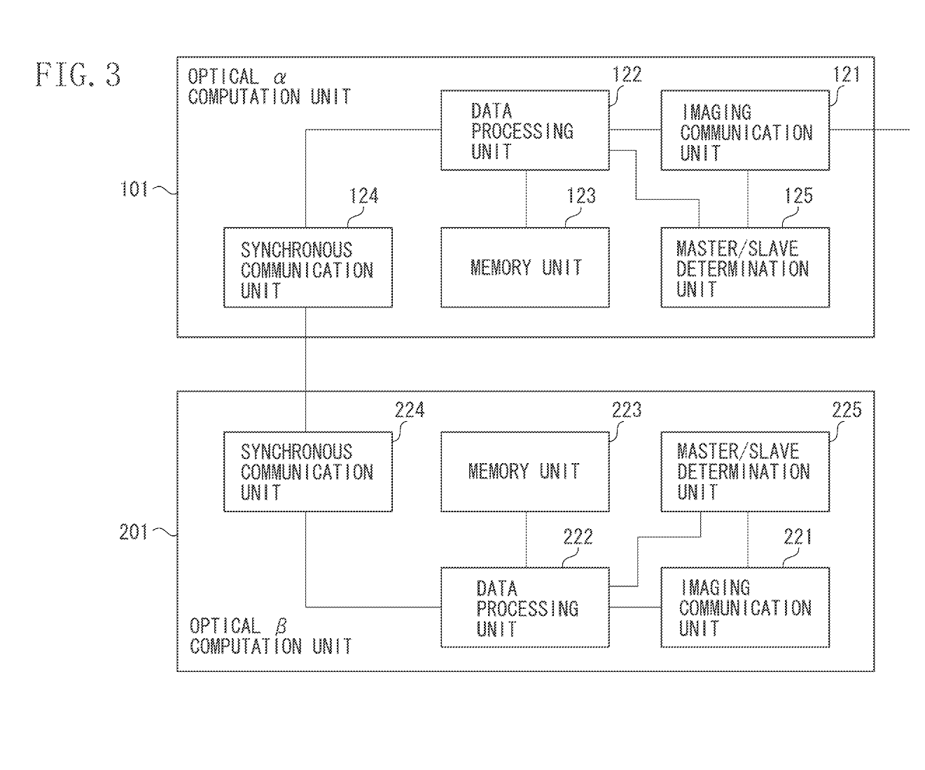

FIG. 3 is a block diagram illustrating an example of the configuration of the optical α computation unit 101 and the optical β computation unit 201.

In the following description, the optical α computation unit 101 operates as a master and the optical β computation unit 201 operates as a slave. However, since the optical α computation unit 101 and the optical β computation unit 201 have a similar configuration, they can operate as a master or a slave.

The optical α computation unit 101 includes an imaging communication unit (a first communication unit) 121, a data processing unit 122, a memory unit 123, a synchronous communication unit 124 (a second communication unit), and a master/slave determination unit 125. The imaging communication unit 121 can receive a control command from the imaging computation unit 11.

The data processing unit 122 is connected to the imaging communication unit 121. When being set to a master state, the data processing unit 122 can convert the control command received by the imaging communication unit 121 into a control command for the optical unit α100 and a control command for the optical unit β200 and write those control commands into the memory unit 123.

The optical α computation unit 101 drives the lens group of the optical unit α100 using the control command for the optical α unit 100 stored in the memory unit 123.

The master/slave determination unit 125 is connected to the imaging communication unit 121 and the data processing unit 122. When the optical unit α100 is powered on, the master/slave determination unit 125 transmits, to the data processing unit 122, a signal indicating an instruction for the setting to a slave state (a slave setting signal). When receiving the slave setting signal, the data processing unit 122 is set to the slave state.

The imaging communication unit 12, when receiving a control signal from the imaging computation unit 11, transmits, to the master/slave determination unit 125, a signal indicating the establishment of communication with the imaging computation unit 11 (a communication establishment signal). The master/slave determination unit 125, when receiving the communication establishment signal, transmits, to the data processing unit 122, a signal indicating an instruction for the setting to a master state (a master setting signal). When receiving the master setting signal, the data processing unit 122 is set to the master state. In a state where a serial communication is established between the imaging communication unit 121 and the imaging computation unit 11, the data processing unit 122 operates in the master state. More specifically, the data processing unit 122 performs processing for converting the control command into a control command for the optical unit α100 itself and a control command for the optical unit β200.

The optical β computation unit 201 includes an imaging communication unit 221, a data processing unit 222, a memory unit 223, a synchronous communication unit 224, and a master/slave determination unit 225. The synchronous communication unit 124 in the optical α computation unit 101 can transmit, to the synchronous communication unit 224 in the optical β computation unit 201, the control command for the optical unit β200, which is stored in the memory unit 123, via the data processing unit 122.

The memory unit 223 can store the control command for the optical unit β200, which is received by the synchronous communication unit 224, via the data processing unit 222.

In the above-described way, the optical β computation unit 201 can receive the control command for the optical unit β from the optical α computation unit 101. In addition, the optical β computation unit 201 drives the lens group of the optical unit β200 using the control command for the optical unit β200 stored in the memory unit 223, so that the lens group of the optical unit α100 can operate in synchronization with the lens group of the optical unit β200.

In addition, the memory unit 123 in the optical α computation unit 101 and the memory unit 223 in the optical β computation unit 201 each can store a feedback signal indicating position information about the lens group of the associated optical unit α100 or optical unit β200.

The feedback signal for the optical unit β200, which is stored in the memory unit 223, can be stored in the memory unit 123 of the optical α computation unit 101 via the data processing unit 222, the synchronous communication unit 224, the synchronous communication unit 124, and the data processing unit 122.

The feedback signals for the optical unit α100 and the optical unit β200, which are stored in the memory unit 123, can be transmitted to the imaging computation unit 11 via the data processing unit 122 and the imaging communication unit 121.

With such a configuration, the imaging unit α110 and the imaging unit β210 can use the feedback signals for the optical unit α100 and the optical unit β200.

When the state where a serial communication is established between the imaging communication unit 121 and the imaging computation unit 11 shifts to a state where a serial communication is not established therebetween, the imaging communication unit 121 transmits, to the master/slave determination unit 125, a signal indicating the unestablishment of communication with the imaging computation unit 11 (a communication unestablishment signal). The master/slave determination unit 125, when receiving the communication unestablishment signal, transmits, to the data processing unit 122, a signal indicating an instruction for the setting to a slave state (a slave setting signal). When receiving the slave setting signal, the data processing unit 122 is set to the slave state.

The imaging communication unit 221 and the master/slave determination unit 225 in the optical β computation unit 201 have functions similar to those of the imaging communication unit 121 and the master/slave determination unit 125 in the optical α computation unit 101. However, when the imaging communication unit 221 does not receive a control command from the imaging computation unit 11 and the communication establishment signal is not transmitted from the imaging communication unit 221 to the master/slave determination unit 225, the master setting signal is not transmitted from the master/slave determination unit 225 to the data processing unit 222. As a result, the data processing unit 222 is not set to the master state and thus continues operating in the slave state.

According to an exemplary embodiment of the present invention, an optical apparatus that performs stereoscopic photography with two or more combinations of an optical unit and an imaging unit, wherein all the optical units can operate in synchronization with a command from an imaging unit and a master and a slave can be easily set, can be provided.

The operation of the lens apparatuses according to the present exemplary embodiment will now be described in detail. A lens apparatus is connected to an imaging unit (camera body), and is also connected to another lens apparatus that is connected to another imaging unit (camera body). The lens apparatus includes a movable optical member (first movable optical member) and a lens control unit (optical computation unit). The movable optical member moves during zooming and/or focusing. The lens control unit controls driving of the movable optical member. Here, the lens control unit controls the movable optical member based on a control command from the imaging unit (camera body) to which the lens apparatus is connected, or based on a control command that is obtained by combining both a control command from the imaging unit and a control command from the foregoing another imaging unit. The lens apparatus is characterized in the provision of a drive unit that thus drives a movable optical member based on a control command from an imaging unit or a combined control command obtained by combining control commands from two imaging units. The lens apparatus further includes a communication unit that transmits a control command from an imaging unit or a combined control command obtained by combining control commands from two imaging units to the foregoing another lens apparatus. The lens apparatus thereby indirectly controls the driving of a movable optical member in the other lens apparatus. The lens apparatus and the other lens apparatus each include a position detection unit that detects the position of a movable optical member. The lens apparatus may change (modify) a control command to be transmitted to the other lens apparatus so that the position of the movable optical member in the lens apparatus (a detection result of the position detection unit) and the position of the movable optical member in the other lens apparatus (a detection result of the position detection unit) have a smaller difference (come to optically closer positions). The lens apparatus may further change (modify) a control command to be transmitted to the other lens apparatus so that the position of the movable optical member in the lens apparatus (a detection result of the position detection unit) and the position of the movable optical member in the other lens apparatus (a detection result of the position detection unit) coincide with each other (come to optically the same positions).

For a modification of the first exemplary embodiment, as mentioned previously, the imaging computation unit (combining unit) 11 may be omitted so that control commands from the imaging α computation unit 111 are directly transmitted to the optical α computation unit 101 (and the optical β computation unit 201). In such a case, all the control commands to the optical units α100 and β200 are output from the imaging α computation unit 111 (imaging unit α110). An optical unit that first establishes connection with the imaging α computation unit 111 becomes a master optical unit. As a result, the optical unit α100, which is mechanically connected to the imaging unit α110, almost inevitably becomes a master, and the optical unit β200 a slave. In such a case, control commands from the imaging β computation unit 211 are ignored. The optical units α110 and β210 drive the movable optical members based only on control commands from the imaging unit α110 (imaging α computation unit 111). With the imaging unit α110 as a master and the imaging unit β210 as a slave, the optical units α100 and β200 are controlled based on control commands from the imaging unit α110 as described above. It will be understood, however, that control commands from the imaging unit β210 may be used. A master and a slave may be set by a photographer (operator) operating the imaging units α110 and β210 or an additional operation member.

In the modification, the imaging unit α110 may generate a combined control command by combining a control command from the imaging unit α110 itself and a control command output from the imaging unit β210, and output the combined control command to the optical unit α100. In such a case, the imaging α computation unit 111 may be configured to receive the output from the imaging β computation unit 211, perform computing based on the output, and output the computation result to the optical α computation unit 110.

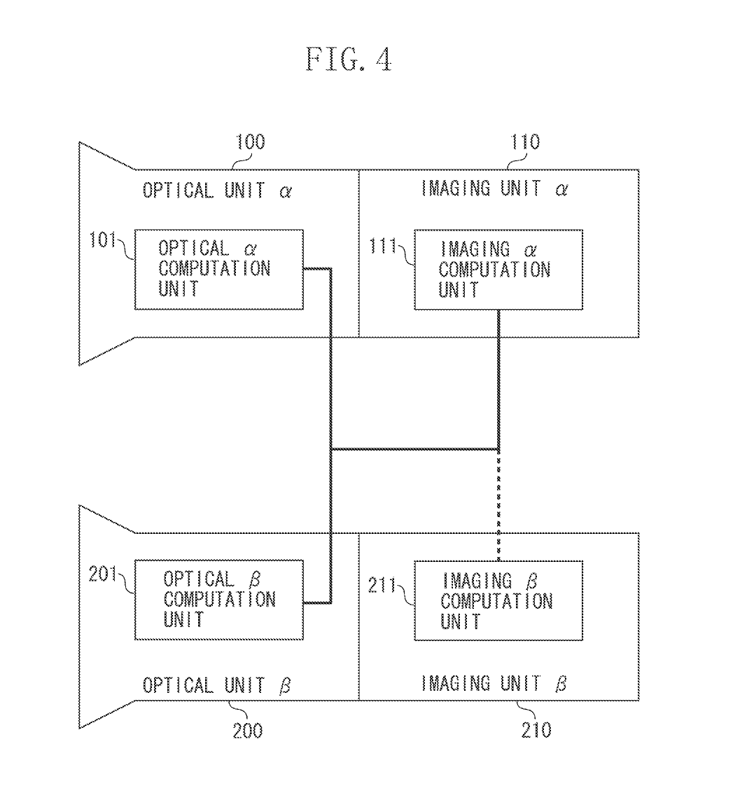

Referring to FIG. 4, a block diagram illustrating the configuration of an optical apparatus according to a second exemplary embodiment of the present invention will be described below.

An optical α computation unit 101 included in an optical unit α (first optical unit) 100 is connected in a parallel state to either one of an imaging α computation unit 111 included in an imaging unit α (first imaging unit) 110 and an imaging β computation unit 211 included in an imaging unit β (second imaging unit) 210. An optical β computation unit 201 included in an optical unit β (second optical unit) 200 is similarly connected in a parallel state to either one of the imaging α computation unit 111 included in the imaging unit α (first imaging unit) 110 and the imaging β computation unit 211 included in the imaging unit β (second imaging unit) 210. In the present exemplary embodiment, the optical α computation unit 101 and the optical β computation unit 201 are connected only to the imaging α computation unit 111. In other words, the optical β computation unit 211 is not connected to the optical units α100 and β200.

While the present exemplary embodiment deals with the configuration that the imaging α computation unit 111 is connected to the optical α computation unit 101 and the optical β computation unit 201, the imaging α computation unit 111 may be replaced with the imaging β computation unit 211 or the not-illustrated imaging computation unit 11 of the first exemplary embodiment.

The connection in a parallel state refers to the following state. Signals output from the imaging α computation unit 111 are distributed in parallel and input to the optical α computation unit 101 and the optical β computation unit 201. Signals output from either one of the optical α computation unit 101 and the optical β computation unit 201 are exclusively input to the imaging α computation unit 111. A control command from the imaging α computation unit 111 is a signal output from the imaging α computation unit 111, and can thus be input to the optical α computation unit 101 and the optical β computation unit 201. The imaging α computation unit 111 can be connected to the optical α computation unit 101 and the optical β computation unit 201 by either parallel connection that transfers (transmits) information in an analog manner or serial connection that digitally transfers (transmits) information.

With the present configuration, a control command from the imaging α computation unit 111 is simultaneously passed to the optical α computation unit 101 and the optical β computation unit 201. Lens groups of the optical units α100 and β200 that include the respective computation units 101 and 201 can thus be operated in synchronization with the control command. In other words, according to the present exemplary embodiment, the connection in the parallel state functions as a command distribution unit. In the present exemplary embodiment, the lens groups of the respective optical units α100 and β200 can be operated in synchronization with each other without setting a master and a slave between the optical units α100 and β200.

According to an exemplary embodiment of the present invention, an optical apparatus that performs stereoscopic photography with two or more combinations of an optical unit and an imaging unit, wherein all the optical units can operate in synchronization with a command from an imaging unit and a master and a slave can be easily set, can be provided.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-172969 filed Aug. 8 2011, which is hereby incorporated by reference herein in its entirety.

What is claimed is:

1. An imaging system comprising:
at least a first imaging apparatus; and
at least a second imaging apparatus,
wherein the at least first imaging apparatus and the at least second imaging apparatus each include:
a camera apparatus including an image sensor; and
a lens apparatus configured to guide an object image to the image sensor,
wherein the lens apparatus is attached to the camera apparatus,
wherein the lens apparatus from either the at least first imaging apparatus or the at least second imaging apparatus is set as a master side lens apparatus by receiving a control command including one of a non-combined control command from the camera apparatus of either the at least first imaging apparatus or the at least second imaging apparatus and a combined control command generated by combining control commands from the camera apparatus of each of the at least first imaging apparatus and the at least second imaging apparatus, and
wherein the control command is transmitted to a slave side lens apparatus via the master side lens apparatus to control the slave side lens apparatus, wherein the slave side lens apparatus is the lens apparatus other than the master side lens apparatus.

2. The imaging system according to claim 1, wherein the imaging system drives a master side member to be controlled for the master side lens apparatus to control and a slave side member to be controlled for the slave side lens apparatus to control based on the control command,
wherein the imaging system further comprises:
a master side position detection unit configured to detect a position of the master side member to be controlled; and
a slave side position detection unit configured to detect a position of the slave side member to be controlled, and
wherein the imaging system modifies the control command to be transmitted to the slave side lens apparatus based on a detection result of the master side position detection unit and a detection result of the slave side position detection unit.

3. The imaging system according to claim 2, wherein the imaging system modifies the control command to be transmitted to the slave side lens apparatus based on the detection result of the master side position detection unit and the detection result of the slave side position detection unit so that a difference between the two detection results decreases.

4. The imaging system according to claim 1, wherein the lens apparatus of the at least first image apparatus is capable of receiving the control command without intervention of the lens apparatus of the at least second imaging apparatus and the lens apparatus of the at least second imaging apparatus is capable of receiving the control command without intervention of the lens apparatus of the at least first imaging apparatus.

5. A lens apparatus connected to a first camera apparatus including a first image sensor and to a second lens apparatus, which is attached to a second camera apparatus including a second image sensor and configured to guide an object image to the second image sensor, the lens apparatus comprising:
a first movable optical member;
a first communication unit configured to receive a control command including one of a first control command from the first camera apparatus and a combined control command generated by combining the first control command from the first camera apparatus and a second control command from the second camera apparatus;
a drive unit configured to drive the first movable optical member based on the control command; and
a second communication unit configured to transmit the control command to the second lens apparatus.

6. The lens apparatus according to claim 5, further comprising:
a first position detection unit configured to detect a position of the first movable optical member; and
a control unit configured to receive a detection result from a second position detection unit configured to detect a position of a second movable optical member included in the second lens apparatus, and to modify the control command to be transmitted to the second lens apparatus based on a detection result of the first position detection unit and the detection result of the second position detection unit.

7. The lens apparatus according to claim 5, wherein, in response to reception of the control command via the first communication unit, the lens apparatus is set to a master-side lens apparatus and transmits the control command to the second lens apparatus via the second communication unit.

8. A computation device connected to a first lens apparatus including a first movable optical member, a first camera apparatus connected to the first lens apparatus, and a second camera apparatus including a second movable optical members connected to the second lens apparatus,
wherein the computation device transmits a combined control command to the first lens apparatus, receives position information on the first movable optical member and transmits the position information on the first movable optical member to the first camera apparatus, acquires position information on the second movable optical member via the first lens apparatus and transmits the position information on the second movable optical member to the second camera apparatus, wherein the combined control command is generated by combining a first control command from the first camera apparatus and a second control command from the second camera apparatus.

9. The computation device according to claim 8, wherein the computation device is attachable to the first camera apparatus or the first lens apparatus, and
wherein the computation device further comprises a wireless receiver transmitter configured to transmit and receive information to/from the second camera apparatus.
